(19) United States
(12) Patent Application Publication
(10) Pub. No.: US 2026/0253460 A1
(43) Pub. Date: Aug. 27, 2026

(54) TRACTOR-TRAILER SYSTEM POSE DERIVATION METHOD, TRACTOR-TRAILER SYSTEM, AND COMPUTER-READABLE STORAGE MEDIUM

(71) Applicant: UBTECH ROBOTICS CORP LTD, Shenzhen (CN)

(72) Inventors: XIN FU, Shenzhen (CN); Jichao Jiao, Shenzhen (CN)

(21) Appl. No.: 19/402,825

(22) Filed: Nov. 26, 2025

(30) Foreign Application Priority Data
Feb. 26, 2025 (CN) 202510221533.0

(51) Int. Cl. G07C 5/04

(52) U.S. Cl. CPC G07C 5/04

(57) ABSTRACT

A tractor-trailer system pose derivation method, a tractor-trailer system, and a computer-readable storage medium. The method includes: determining an initial pose state of a tractor-trailer system; obtaining a real-time position of the tractor of the tractor-trailer system, and determining the real-time position of the tractor as a target position; obtaining a linear speed and a steering rudder angle of the tractor by processing the initial pose state and the target position using a preset trajectory tracking controller; and obtaining a target pose state of the tractor-trailer system by processing the initial pose state, the linear speed, and the steering rudder angle using a preset differential algebraic equation solver. In this manner, the, the poses of the tractor-trailer system can be accurately deduced, thereby facilitating the application of autonomous driving technology in the tractor-trailer system.

### CROSS REFERENCE TO RELATED APPLICATIONS

The present disclosure claims priority to Chinese Patent Application No. 202510221533.0, filed Feb. 26, 2025, which is hereby incorporated by reference herein as if set forth in its entirety.

### TECHNICAL FIELD

The present disclosure relates to autonomous driving technology, and particularly to a tractor-trailer system pose derivation method, a tractor-trailer system, and a computer-readable storage medium.

### BACKGROUND

Tractor-trailer systems are widely used in fields such as logistics and transportation, engineering construction, and agricultural production, which have broad application prospects when combined with autonomous driving technology. Unlike the traditional single rigid vehicle, a tractor-trailer system will have the motion modes with multiple degrees of freedom when turning, and its complex articulated structure allows its vehicle to exhibit unique kinematics and dynamics characteristics during operation. As a result, how to perform accurate pose derivations is an urgent problem needed to be solved while applying the current autonomous driving technology to tractor-trailer systems.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a schematic diagram of a tractor-trailer system according to an embodiment of the present disclosure.

FIG. 2 is a flow chart of a tractor-trailer system pose derivation method according to an embodiment of the present disclosure.

FIG. 3 is a flow chart of deducing trajectory for a tractor-trailer system according to an embodiment of the present disclosure.

FIG. 4 is a schematic diagram of the structure of a tractor-trailer system pose derivation apparatus according to an embodiment of the present disclosure.

FIG. 5 is a schematic diagram of an electronic device according to an embodiment of the present disclosure.

### DETAILED DESCRIPTION

In order to make the objects of the present disclosure, the features and advantages may be more obvious and easy to understand, the technical solutions in the embodiments of the present disclosure will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “one”, “a”, and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” in response to determining” or “in response to detecting”. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the present disclosure, the terms “first”, “second”, “third”, and the like in the descriptions are only used for distinguishing, and cannot be understood as indicating or implying relative importance.

Tractor-trailer systems are widely used in fields such as logistics and transportation, engineering construction, and agricultural production, which have broad application prospects when combined with autonomous driving technology. Unlike the traditional single rigid vehicle, a tractor-trailer system will have the motion modes with multiple degrees of freedom when turning, and its complex articulated structure allows its vehicle to exhibit unique kinematics and dynamics characteristics during operation. As a result, how to perform accurate pose derivations is an urgent problem needed to be solved while applying the current autonomous driving technology to tractor-trailer systems.

In view of this, the embodiments of the present disclosure provide a tractor-trailer system pose derivation method, a tractor-trailer system, and a computer-readable storage medium so as to solve the problem in the prior art that the poses (i.e., the positions and the postures) of the tractor-trailer system are difficult to be derived accurately.

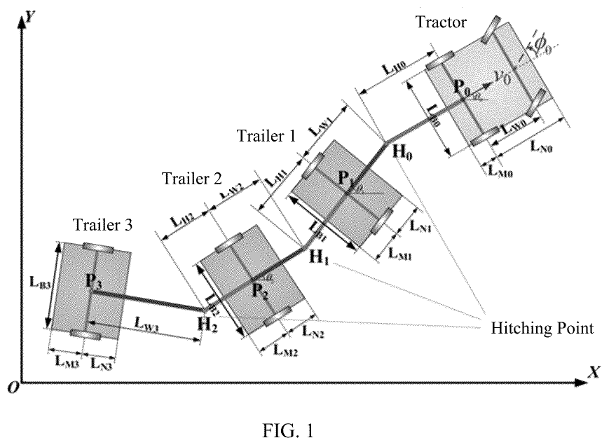

FIG. 1 is a schematic diagram of a tractor-trailer system according to an embodiment of the present disclosure. The tractor-trailer system may include a tractor and a plurality of trailers. The tractor refers to a vehicle with driving ability to tow the trailers, and the trailer refers to a vehicle without driving ability and towed by the tractor. The specific number of the trailers may be flexibly set according to the actual needs. As shown in FIG. 1, the case with three trailers is proposed as an example.

An accurate tractor-trailer system kinematics model may be established based on the tractor-trailer system in FIG. 1. In which, the state of the tractor is as an equation of:

$$[ \begin{matrix}{\dot{x}}_{0} ( t ) \\ {\dot{y}}_{0} ( t ) \\ {\dot{θ}}_{0} ( t )\end{matrix} ] = [ \begin{matrix}{v}_{0} ( t ) \cdot cos {θ}_{0} ( t ) \\ {v}_{0} ( t ) \cdot sin {θ}_{0} ( t ) \\ {v}_{0} \cdot tan {ϕ}_{0} ( t ) / {L}_{W 0}\end{matrix} ] ;$$

and the state of the trailer is as equations of:

$${\dot{θ}}_{i} ( t ) = {v}_{i - 1} ( t ) \cdot sin ( {θ}_{i - 1} ( t ) - {θ}_{i} ( t ) ) / {L}_{Wi} - {L}_{H ( i - 1 )} / {L}_{Wi} \cdot cos ( {θ}_{i - 1} ( t ) - {θ}_{i} ( t ) ) \cdot {\dot{θ}}_{i - 1} ( t ) ;$$

$${v}_{i} ( t ) = {v}_{i - 1} ( t ) \cdot cos ( {θ}_{i - 1} ( t ) - {θ}_{i} ( t ) ) + {L}_{H ( i - 1 )} \cdot sin ( {θ}_{i - 1} ( t ) - {θ}_{i} ( t ) ) \cdot {\dot{θ}}_{i - 1} ( t ) ; and$$

$$i = 1 , … , N$$

where, the subscript of 0 represents the status quantity of the tractor, and the subscript of larger than or equal to 1 represents the status quantity of the trailer; N is the number of the trailers; P₀ is the midpoint of the rear axle of the tractor, and Pᵢ (i=1, . . . , N) is the midpoint of the axle of the i-th trailer; H₀ is the hitching point between the tractor and the 1-st trailer, and Hᵢ (i=1, . . . , N−1) is the hitching point between the i-th trailer and the i+1-th trailer; L_{Hi} (i=0, 1, . . . , N−1) is the distance between Pᵢ and Hᵢ, L_{W0} is the distance between the midpoint of the front axle and that of the rear axle of the tractor, and L_{Wi} (i=1, . . . , N) is the distance between Hᵢ₋₁ and Pᵢ; and (xᵢyᵢθᵢvᵢ) (i=0, 1, . . . , N) respectively represents the horizontal axis coordinate, the vertical axis coordinate, the climb angle, and the speed of Pᵢ. In particular, v₀ and φ₀ represent the linear speed and the steering rudder angle of the tractor, respectively, as the control variables of the state equation.

The state equation of the tractor and that of the trailer may jointly form the differential-algebraic equation (DAE) of the tractor-trailer system.

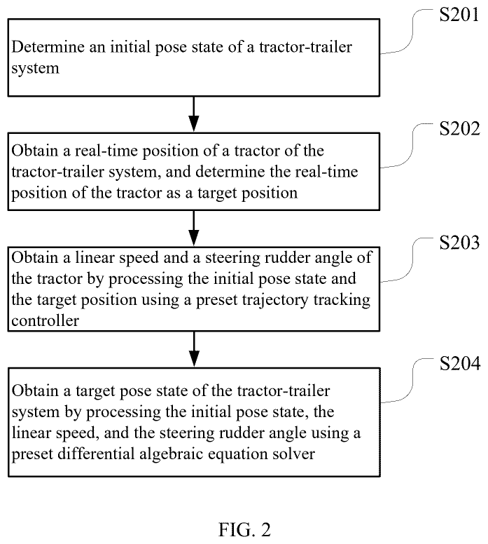

FIG. 2 is a flow chart of a tractor-trailer system pose derivation method according to an embodiment of the present disclosure. A tractor-trailer system pose derivation method is provided based on the established kinematics model of the tractor-trailer system. In this embodiment, the tractor-trailer system pose derivation method may be applied to (a controller of) the tractor of the tractor-trailer system. As shown in FIG. 2, the tractor-trailer system pose derivation method may include the following steps.

S201: determining an initial pose state of the tractor-trailer system.

In which, the initial pose state (denoted as int_tt_s) is the state of the pose (i.e., position and posture) of the tractor-trailer system at the starting moment of pose derivation, where the initial pose state is a known quantity.

S202: obtaining a real-time position of the tractor of the tractor-trailer system, and determining the real-time position of the tractor as a target position.

In this embodiment, a Global Navigation Satellite System (GNSS) based position sensor may be deployed in the tractor, and the real-time position of the tractor may be obtained through the position sensor to use as the target position (denoted as target_tractor_s).

In which, the GNSS may include at least one of Beidou Satellite Navigation System (BDS), Global Positioning System (GPS), GLObal Navigation Satellite System (GLONASS) and Galileo satellite navigation system (Galileo).

In one embodiment, after determining the target position, it may further determine the validity of the target position. For example, whether the target position is a reachable position or not, and if no, it may return to perform step S202, that is, reobtaining the real-time position of the tractor to use as the new target position, then further determine the validity of the target position. If the target position is valid, it may continue to perform step S203 and the subsequent steps.

S203: obtaining a linear speed and a steering rudder angle of the tractor by processing the initial pose state and the target position using a preset trajectory tracking controller

In this embodiment, any trajectory tracking controller of the existing technology may be used according to actual needs to input the initial pose state and the target position into the trajectory tracking controller so as to obtain the linear speed and the steering rudder angle of the tractor output by the trajectory tracking controller.

S204: obtaining a target pose state of the tractor-trailer system by processing the initial pose state, the linear speed, and the steering rudder angle using a preset differential algebraic equation solver.

The differential algebraic equation solver is configured to solve the differential algebraic equation of the tractor-trailer system. In this embodiment, any differential algebraic equation solver in the existing technology may be used according to the actual needs to input the initial pose state, the linear speed, and the steering rudder angle into the differential algebraic equation solver so as to obtain the target pose state (denoted as target_tt_s) of the tractor-trailer system output by the differential algebraic equation solver.

It should be noted that the foregoing process is merely one pose derivation process, and in actual use, the pose derivation process can be performed continuously. In this case, it may determine the target pose state of the tractor-trailer system as a new initial pose state, and return to perform step S202 and the subsequent steps, thereby deriving the pose of the tractor-trailer system continuously.

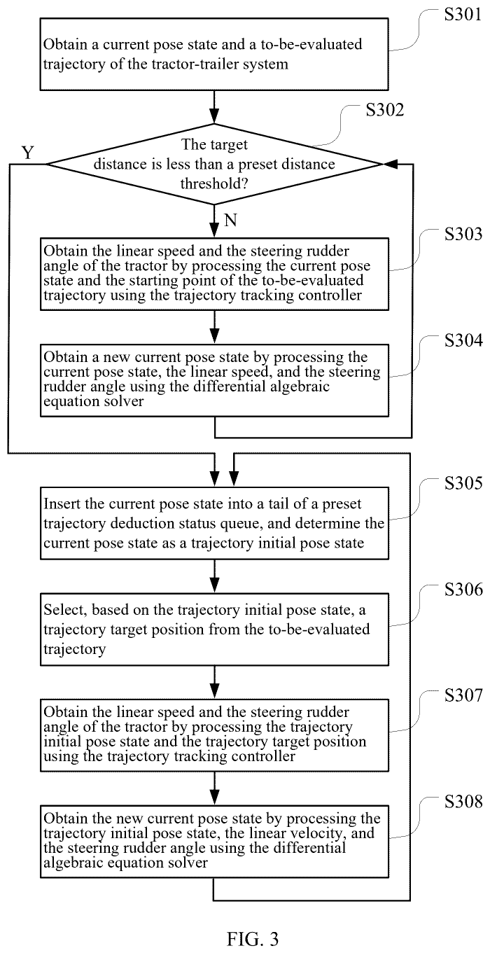

In this embodiment, on the basis of deriving the pose of the tractor-trailer system, further trajectory deductions may be performed by, for example, giving a planned trajectory (i.e., the to-be-evaluated trajectory, denoted as target_traj) to simulate, through the pose state of the tractor-trailer system at the starting point of the to-be-evaluated trajectory that has determined through the above-mentioned pose derivation process, the actual trajectory of the tractor and the trailer when the tractor tracks the to-be-evaluated trajectory using a certain open-loop or closed-loop trajectory tracking algorithm. FIG. 3 is a flow chart of deducing trajectory for a tractor-trailer system according to an embodiment of the present disclosure. As shown in FIG. 3, the process of deducing the trajectory for the tractor-trailer system may include the following steps.

S301: obtaining a current pose state and a to-be-evaluated trajectory of the tractor-trailer system.

In which, the current pose state of the tractor-trailer system may be obtained through the above-mentioned pose derivation process, which is the latest derived target pose state.

S302: determining whether the target distance is less than a preset distance threshold.

In which, the target distance is a distance between the position of the tractor in the current pose state and the starting point (denoted as target_traj_point_0) of the to-be-evaluated trajectory. The specific value of the distance threshold may be flexibly set according to actual needs.

In the case that the target distance is larger than or equal to the distance threshold, it means that the tractor is still far away from the starting point of the to-be-evaluated trajectory. At this time, the tractor needs to be moved to the vicinity of the starting point of the to-be-evaluated trajectory, that is, step S303 and the subsequent steps are to be performed.

Otherwise, in the case that the target distance is less than the distance threshold, it means that the tractor is near the starting point of the to-be-evaluated trajectory. At this time, the tractor may be directly moved along the to-be-evaluated trajectory, that is, step S305 and the subsequent steps are to be performed.

S303: obtaining the linear speed and the steering rudder angle of the tractor by processing the current pose state and the starting point of the to-be-evaluated trajectory using the trajectory tracking controller.

The specific usage of the trajectory tracking controller is similar to step S203. For details, the description of step S203 can be referred.

S304: obtaining a new current pose state by processing the current pose state, the linear speed, and the steering rudder angle using the differential algebraic equation solver.

The specific usage of the differential algebraic equation solver is similar to step S204. For details, the description of step S204 can be referred. After obtaining the new current pose state, it may return to perform step S302 and the subsequent steps.

S305: inserting the current pose state into a tail of a preset trajectory deduction status queue, and determining the current pose state as a trajectory initial pose state.

In which, the trajectory deduction status queue (denoted as traj_tt_s_list) is an empty queue at the beginning. Whenever a new current pose state is obtained during the trajectory deduction process, it will be inserted into the tail of the trajectory deduction status queue, so that the complete trajectory deduction result can be recorded, and the current pose state will be used as the trajectory initial pose state (denoted as traj_int_tt_s).

S306: selecting, based on the trajectory initial pose state, a trajectory target position from the to-be-evaluated trajectory.

In this embodiment, the position in the to-be-evaluated trajectory that meets a preset condition may be selected as the trajectory target position (denoted as traj_target_tractor_s). In which, the preset condition may include being located in front of an initial position and separated from the initial position by a preset distance interval, where the initial position is the tractor position in the trajectory initial pose state. The specific value of the distance interval may be flexibly set according to actual needs.

In this embodiment, after determining the trajectory target position, it may further determine the validity of the trajectory target position by, for example, determining whether the trajectory target position is an accessible position. If the trajectory target position is invalid, the deduction of the to-be-evaluated trajectory may be ended to output the trajectory deduction status queue. Otherwise, if the trajectory target position is valid, it may continue to perform step S307 and the subsequent steps.

S307: obtaining the linear speed and the steering rudder angle of the tractor by processing the trajectory initial pose state and the trajectory target position using the trajectory tracking controller.

The specific usage of the trajectory tracking controller is similar to step S203. For details, the description of step S203 can be referred.

S308: obtaining the new current pose state by processing the trajectory initial pose state, the linear velocity, and the steering rudder angle using the differential algebraic equation solver.

The specific usage of the differential equation solver is similar to step S204. For details, the description of step S204 can be referred. After obtaining the new current pose state, it may continue to perform step S305 and the subsequent steps.

Through the foregoing process, the trajectory deduction for the tractor-trailer system will be continuously performed along the to-be-evaluated trajectory. After completing the deduction of the to-be-evaluated trajectory, the trajectory deduction status queue may be output. In which, the complete trajectory deduction result will be recorded in the trajectory deduction status queue.

After obtaining the trajectory deduction status queue, the feasibility of the to-be-evaluated trajectory may be evaluated based on the trajectory deduction status queue. For example, it may include whether a collide with obstacles will occur, whether covering lane lines, or the like, thereby obtaining a feasibility evaluation result of the to-be-evaluated trajectory.

To sum up, in this embodiment, the method includes: determining an initial pose state of a tractor-trailer system; obtaining a real-time position of the tractor of the tractor-trailer system, and determining the real-time position of the tractor as a target position; obtaining a linear speed and a steering rudder angle of the tractor by processing the initial pose state and the target position using a preset trajectory tracking controller; and obtaining a target pose state of the tractor-trailer system by processing the initial pose state, the linear speed, and the steering rudder angle using a preset differential algebraic equation solver. In this manner, the, the poses of the tractor-trailer system can be accurately deduced, thereby facilitating the application of autonomous driving technology in the tractor-trailer system.

It should be understood that, the sequence of the serial number of the steps in the above-mentioned embodiments does not mean the execution order while the execution order of each process should be determined by its function and internal logic, which should not be taken as any limitation to the implementation process of the embodiments.

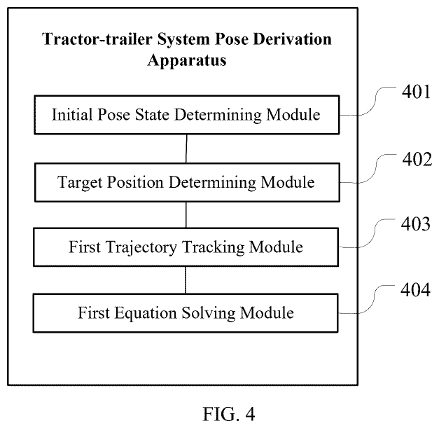

FIG. 4 is a schematic diagram of the structure of a tractor-trailer system pose derivation apparatus according to an embodiment of the present disclosure. A tractor-trailer system pose derivation apparatus corresponding to the above-mentioned tractor-trailer system pose derivation method is provided.

As shown in FIG. 4, in this embodiment, the tractor-trailer system pose derivation apparatus may include:

an initial pose state determining module 401 is configured to determine an initial pose state of the tractor-trailer system;

a target position determining module 402 is configured to obtain a real-time position of the tractor of the tractor-trailer system, and determining the real-time position of the tractor as a target position;

a first trajectory tracking module 403 is configured to obtain a linear speed and a steering rudder angle of the tractor by processing the initial pose state and the target position using a preset trajectory tracking controller; and

a first equation solving module 404 is configured to obtain a target pose state of the tractor-trailer system by processing the initial pose state, the linear speed, and the steering rudder angle using a preset differential algebraic equation solver.

In this embodiment, the tractor-trailer system pose derivation apparatus may further include:

a target position validity determining module configured to determine whether the target position is valid; return to obtaining the real-time position of the tractor, in response to the target position being invalid; and continue to obtaining the linear speed and the steering rudder angle of the tractor, in response to the target position being valid.

In this embodiment, the tractor-trailer system pose derivation apparatus may further include:
a current pose state obtaining module configured to obtain a current pose state and a to-be-evaluated trajectory of the tractor-trailer system;
a target distance determining module configured to determine whether the target distance is less than a preset distance threshold, where the target distance is a distance between a tractor position in the current pose state and a starting point of the to-be-evaluated trajectory;
a trajectory initial pose state determining module configured to insert the current pose state into a tail of a preset trajectory deduction status queue in response to the target distance being less than the distance threshold, and determining the current pose state as a trajectory initial pose state;
a trajectory target position selecting module configured to select, based on the trajectory initial pose state, a trajectory target position from the to-be-evaluated trajectory;
a second trajectory tracking module configured to obtain the linear speed and the steering rudder angle of the tractor by processing the trajectory initial pose state and the trajectory target position using the trajectory tracking controller;
a second equation solving module configured to obtain the new current pose state by processing the trajectory initial pose state, the linear velocity, and the steering rudder angle using the differential algebraic equation solver, and returning to inserting the current pose state into the tail of the trajectory deduction status queue; and
a trajectory deduction status queue output module configured to output the trajectory deduction status queue after deducting the to-be-evaluated trajectory.

In this embodiment, the tractor-trailer system pose derivation apparatus may further include:
a third trajectory tracking module configured to obtain the linear speed and the steering rudder angle of the tractor by processing the current pose state and the starting point of the to-be-evaluated trajectory using the trajectory tracking controller, in response to the target distance being larger than or equal to the distance threshold;
a third equation solving module configured to obtain a new current pose state by processing the current pose state, the linear speed, and the steering rudder angle using the differential algebraic equation solver, and return to determining whether the target distance is less than the preset distance threshold.

In this embodiment, the trajectory target position selecting module may be configured to select a position meeting a preset condition from the to-be-evaluated trajectory to take as the trajectory target position, where the preset condition includes being located in front of an initial position and separated from the initial position by a preset distance interval, and the initial position is the tractor position in the trajectory initial pose state.

In this embodiment, the tractor-trailer system pose derivation apparatus may further include:
a feasibility evaluating module configured to obtain a feasibility evaluation result of the to-be-evaluated trajectory by performing a feasibility evaluation on the to-be-evaluated trajectory based on the trajectory deduction status queue.

In this embodiment, the tractor-trailer system pose derivation apparatus may further include:
an initial pose state updating module configured to determine the target pose state of the tractor-trailer system as a new initial pose state, and returning to obtaining the real-time position of the tractor.

Those skilled in the art may clearly understand that, for the convenience and simplicity of description, for the specific operation process of the above-mentioned apparatus, modules and units, reference may be made to the corresponding processes in the above-mentioned method embodiments.

In the above-mentioned embodiments, the description of each embodiment has its focuses, and the parts which are not described or mentioned in one embodiment may refer to the related descriptions in other embodiments.

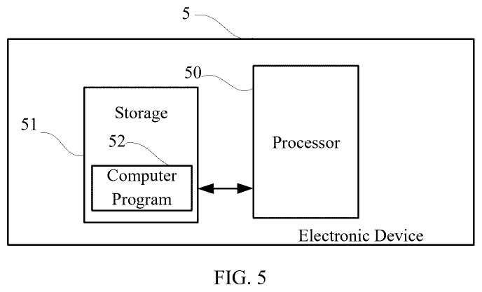

FIG. 5 is a schematic diagram of an electronic device according to an embodiment of the present disclosure. For convenience of explanation, only the parts related to this embodiment are shown.

As shown in FIG. 5, in this embodiment, the electronic device 5 may include a processor 50, a storage 51, and a computer program 52 stored in the storage 51 and executable on the processor 50. When the processor 50 executes the computer program 52, the steps of each of the above-mentioned embodiments of the tractor-trailer system pose derivation method such as steps S201-S204 in FIG. 2 or the functions of the modules/units in each of the above-mentioned apparatus embodiments such as the functions of modules 401-404 in FIG. 4 are implemented.

For example, the computer program 52 may be separated into one or more modules/units stored in the storage 51 and executed by the processor 50. The module/unit is a series of computer program instruction sections that can achieve specific function for describing the execution process of the computer program 52 in the electronic device 5.

The electronic device 5 may be a computing device such as a mobile phone, a tablet computer, a desktop computer, a notebook, a handle computer, a robot, and a server. It may be understood by those skilled in the art that FIG. 5 is only an example of the electronic device 5 and does not constitute a limitation on the electronic device 5, and may include more or fewer components than those shown in the figure, or a combination of some components, or different components. For example, the electronic device 5 may further include an input/output device, a network access device, a bus, or the like.

The processor 50 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 51 may be an internal storage unit of the electronic device 5, for example, a hard disk or a memory of the electronic device 5. The storage 51 may also be an external storage device of the electronic device 5, for example, a plug-in hard disk, a smart media card (SMC), a secure digital (SD) card, flash card, and the like, which is equipped on the electronic device 5. Furthermore, the storage 51 may further include both an internal storage unit and an external storage device, of the electronic device 5. The storage 51 is configured to store the computer program 52 and other programs and data required by the electronic device 5. The storage 51 may also be used to temporarily store data that has been or will be output.

Those skilled in the art may clearly understand that, for the convenience and simplicity of description, the division of modules in the above-mentioned functional units is merely an example for illustration. In actual applications, the above-mentioned functions may be allocated to different functional units according to requirements, that is, the internal structure of the device may be allocated into different functional units or modules to complete all or part of the functions described in the above-mentioned embodiments, each functional unit in the embodiments may be integrated into one processing unit, or each unit may exist alone physically, or two or more units may be integrated in one unit. The above-mentioned integrated unit may be implemented in the form of hardware or in the form of software functional unit. In addition, the specific name of each functional unit and the module is merely for the convenience of distinguishing each other and is not intended to limit the scope of the protection of the above-mentioned system, and the specific operation process of the modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those skilled in the art may clearly understand that, the exemplificative units and steps described in the embodiments disclosed herein may be implemented in electronic hardware or a combination of computer software and electronic hardware. Whether these functions are implemented through hardware or software depends on the specific application and design constraints of the technical schemes. Those ordinary skilled in the art may implement the described functions in different manners for each particular application, while this implementation should not be considered as be within the scope of the present disclosure.

In the embodiments provided by the present disclosure, it should be noted that the disclosed apparatus/electronic device and method may be implemented in other manners. For example, the above-mentioned apparatus/electronic device embodiment is merely exemplary. For example, the division of modules or units is merely a logical functional division, and other division manner may be used in actual implementations, for example, multiple units or components may be combined or be integrated into another system, or some of the features may be ignored or not performed. other points, the displayed or disclosure may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the purpose of this embodiment.

In addition, each functional unit in each embodiment of the present disclosure may be integrated into one processing unit, or each unit may exist physically only, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer readable storage medium, which may implement the steps of each of the above-mentioned method embodiments when executed by a processor. In which, the computer program includes computer program codes which may be the form of source codes, object codes, executable files, certain intermediate, and the like. The computer readable medium may include any entity or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be noted by those skilled in the art that, the technical schemes in each of the above-mentioned embodiments may still be modified, or some of the technical features may be equivalently replaced, and these modifications or replacements do not make the essence of the corresponding technical schemes depart from the spirit and scope of the technical schemes of each of the embodiments of the present disclosure, and should be included within the scope of the present disclosure.

What is claimed is:

1. A pose derivation method for a tractor-trailer system having a tractor towing at least a trailer, comprising:
determining an initial pose state of the tractor-trailer system;
obtaining a real-time position of the tractor of the tractor-trailer system, and determining the real-time position of the tractor as a target position;
obtaining a linear speed and a steering rudder angle of the tractor by processing the initial pose state and the target position using a preset trajectory tracking controller; and
obtaining a target pose state of the tractor-trailer system by processing the initial pose state, the linear speed, and the steering rudder angle using a preset differential algebraic equation solver.

2. The method of claim 1, wherein after determining the real-time position of the tractor as the target position, the method further comprises:
determining whether the target position is valid;
returning to obtaining the real-time position of the tractor, in response to the target position being invalid; and
continuing to obtaining the linear speed and the steering rudder angle of the tractor, in response to the target position being valid.

3. The method of claim 1, further comprising:
obtaining a current pose state and a to-be-evaluated trajectory of the tractor-trailer system;
determining whether the target distance is less than a preset distance threshold, wherein the target distance is a distance between a tractor position in the current pose state and a starting point of the to-be-evaluated trajectory;
inserting the current pose state into a tail of a preset trajectory deduction status queue in response to the target distance being less than the distance threshold, and determining the current pose state as a trajectory initial pose state;
selecting, based on the trajectory initial pose state, a trajectory target position from the to-be-evaluated trajectory;
obtaining the linear speed and the steering rudder angle of the tractor by processing the trajectory initial pose state and the trajectory target position using the trajectory tracking controller;
obtaining the new current pose state by processing the trajectory initial pose state, the linear velocity, and the steering rudder angle using the differential algebraic equation solver, and returning to inserting the current pose state into the tail of the trajectory deduction status queue; and
outputting the trajectory deduction status queue after deducting the to-be-evaluated trajectory.

4. The method of claim 3, wherein after determining whether the target distance is less than the preset distance threshold, the method further comprises:
obtaining the linear speed and the steering rudder angle of the tractor by processing the current pose state and the starting point of the to-be-evaluated trajectory using the trajectory tracking controller, in response to the target distance being larger than or equal to the distance threshold; and
obtaining a new current pose state by processing the current pose state, the linear speed, and the steering rudder angle using the differential algebraic equation solver, and returning to determining whether the target distance is less than the preset distance threshold.

5. The method of claim 3, wherein selecting, based on the trajectory initial pose state, the trajectory target position from the to-be-evaluated trajectory comprises:
selecting a position meeting a preset condition from the to-be-evaluated trajectory to take as the trajectory target position, wherein the preset condition includes being located in front of an initial position and separated from the initial position by a preset distance interval, and the initial position is the tractor position in the trajectory initial pose state.

6. The method of claim 3, wherein after outputting the trajectory deduction status queue after deducting the to-be-evaluated trajectory, the method further comprises:
obtaining a feasibility evaluation result of the to-be-evaluated trajectory by performing a feasibility evaluation on the to-be-evaluated trajectory based on the trajectory deduction status queue.

7. The method of claim 1, wherein after obtaining the target pose state of the tractor-trailer system, the method further comprises:
determining the target pose state of the tractor-trailer system as a new initial pose state, and returning to obtaining the real-time position of the tractor.

8. A tractor-trailer system, comprising:
a tractor towing at least a trailer;
a processor;
a memory coupled to the processor; and
one or more computer programs stored in the memory and executable on the processor;
wherein, the one or more computer programs comprise:
instructions for determining an initial pose state of the tractor-trailer system;
instructions for obtaining a real-time position of the tractor of the tractor-trailer system, and determining the real-time position of the tractor as a target position;
instructions for obtaining a linear speed and a steering rudder angle of the tractor by processing the initial pose state and the target position using a preset trajectory tracking controller; and
instructions for obtaining a target pose state of the tractor-trailer system by processing the initial pose state, the linear speed, and the steering rudder angle using a preset differential algebraic equation solver.

9. The system of claim 8, wherein the one or more computer programs further comprise:
instructions for determining whether the target position is valid;
instructions for returning to obtaining the real-time position of the tractor, in response to the target position being invalid; and
instructions for continuing to obtaining the linear speed and the steering rudder angle of the tractor, in response to the target position being valid.

10. The system of claim 8, the one or more computer programs further comprise:
instructions for obtaining a current pose state and a to-be-evaluated trajectory of the tractor-trailer system;
instructions for determining whether the target distance is less than a preset distance threshold, wherein the target distance is a distance between a tractor position in the current pose state and a starting point of the to-be-evaluated trajectory;
instructions for inserting the current pose state into a tail of a preset trajectory deduction status queue in response to the target distance being less than the distance threshold, and determining the current pose state as a trajectory initial pose state;
instructions for selecting, based on the trajectory initial pose state, a trajectory target position from the to-be-evaluated trajectory;
instructions for obtaining the linear speed and the steering rudder angle of the tractor by processing the trajectory initial pose state and the trajectory target position using the trajectory tracking controller;
instructions for obtaining the new current pose state by processing the trajectory initial pose state, the linear velocity, and the steering rudder angle using the differential algebraic equation solver, and returning to inserting the current pose state into the tail of the trajectory deduction status queue; and
instructions for outputting the trajectory deduction status queue after deducting the to-be-evaluated trajectory.

11. The system of claim 10, the one or more computer programs further comprise:
instructions for obtaining the linear speed and the steering rudder angle of the tractor by processing the current pose state and the starting point of the to-be-evaluated trajectory using the trajectory tracking controller, in response to the target distance being larger than or equal to the distance threshold; and
instructions for obtaining a new current pose state by processing the current pose state, the linear speed, and the steering rudder angle using the differential algebraic equation solver, and returning to determining whether the target distance is less than the preset distance threshold.

12. The system of claim 10, wherein the instructions for selecting, based on the trajectory initial pose state, the trajectory target position from the to-be-evaluated trajectory comprise:
instructions for selecting a position meeting a preset condition from the to-be-evaluated trajectory to take as the trajectory target position, wherein the preset condition includes being located in front of an initial position and separated from the initial position by a preset distance interval, and the initial position is the tractor position in the trajectory initial pose state.

13. The system of claim 10 wherein the one or more computer programs further comprise:
instructions for obtaining a feasibility evaluation result of the to-be-evaluated trajectory by performing a feasibility evaluation on the to-be-evaluated trajectory based on the trajectory deduction status queue.

14. The system of claim 8, wherein the one or more computer programs further comprise:
instructions for determining the target pose state of the tractor-trailer system as a new initial pose state, and returning to obtaining the real-time position of the tractor.

15. A non-transitory computer-readable storage medium for storing one or more computer programs, wherein the one or more computer programs comprise:
instructions for determining an initial pose state of a tractor-trailer system having a tractor towing at least a trailer;
instructions for obtaining a real-time position of the tractor of the tractor-trailer system, and determining the real-time position of the tractor as a target position;
instructions for obtaining a linear speed and a steering rudder angle of the tractor by processing the initial pose state and the target position using a preset trajectory tracking controller; and
instructions for obtaining a target pose state of the tractor-trailer system by processing the initial pose state, the linear speed, and the steering rudder angle using a preset differential algebraic equation solver.

16. The storage medium of claim 15, wherein the one or more computer programs further comprise:
instructions for determining whether the target position is valid;
instructions for returning to obtaining the real-time position of the tractor, in response to the target position being invalid; and
instructions for continuing to obtaining the linear speed and the steering rudder angle of the tractor, in response to the target position being valid.

17. The storage medium of claim 15, the one or more computer programs further comprise:
instructions for obtaining a current pose state and a to-be-evaluated trajectory of the tractor-trailer system;
instructions for determining whether the target distance is less than a preset distance threshold, wherein the target distance is a distance between a tractor position in the current pose state and a starting point of the to-be-evaluated trajectory;
instructions for inserting the current pose state into a tail of a preset trajectory deduction status queue in response to the target distance being less than the distance threshold, and determining the current pose state as a trajectory initial pose state;
instructions for selecting, based on the trajectory initial pose state, a trajectory target position from the to-be-evaluated trajectory;
instructions for obtaining the linear speed and the steering rudder angle of the tractor by processing the trajectory initial pose state and the trajectory target position using the trajectory tracking controller;
instructions for obtaining the new current pose state by processing the trajectory initial pose state, the linear velocity, and the steering rudder angle using the differential algebraic equation solver, and returning to inserting the current pose state into the tail of the trajectory deduction status queue; and
instructions for outputting the trajectory deduction status queue after deducting the to-be-evaluated trajectory.

18. The storage medium of claim 17, the one or more computer programs further comprise:
instructions for obtaining the linear speed and the steering rudder angle of the tractor by processing the current pose state and the starting point of the to-be-evaluated trajectory using the trajectory tracking controller, in response to the target distance being larger than or equal to the distance threshold; and
instructions for obtaining a new current pose state by processing the current pose state, the linear speed, and the steering rudder angle using the differential algebraic equation solver, and returning to determining whether the target distance is less than the preset distance threshold.

19. The storage medium of claim 17, wherein the instructions for selecting, based on the trajectory initial pose state, the trajectory target position from the to-be-evaluated trajectory comprise:
instructions for selecting a position meeting a preset condition from the to-be-evaluated trajectory to take as the trajectory target position, wherein the preset condition includes being located in front of an initial position and separated from the initial position by a preset distance interval, and the initial position is the tractor position in the trajectory initial pose state.

20. The storage medium of claim 17, wherein the one or more computer programs further comprise:
instructions for obtaining a feasibility evaluation result of the to-be-evaluated trajectory by performing a feasibility evaluation on the to-be-evaluated trajectory based on the trajectory deduction status queue.
